(19) United States
(12) Patent Application Publication
(10) Pub. No.: US 2025/0329965 A1
(43) Pub. Date: Oct. 23, 2025

(54) GROUND BUS FOR A CABLE CARD ASSEMBLY OF AN ELECTRICAL CONNECTOR

(71) Applicant: TE Connectivity Solutions GmbH, Schaffhausen (CH)

(72) Inventors: Craig Warren Hornung, Harrisburg, PA (US); Chad William Morgan, Carneys Point, NJ (US); John Joseph Consoli, Harrisburg, PA (US); John Eugene Westman, Harrisburg, PA (US)

(21) Appl. No.: 18/643,566

(22) Filed: Apr. 23, 2024

(51) Int. Cl. H01R 13/6594; H01R 13/58

(52) U.S. Cl. CPC H01R 13/6594; H01R 13/5812

(57) ABSTRACT

An electrical connector includes a housing that has walls forming a cavity, a cable exit port at a cable end of the housing, and an opening at a mating end of the housing. The electrical connector includes a cable card assembly received in the cavity of the housing. The cable card assembly includes a circuit card, cables terminated to the circuit card, and a ground bus coupled to the circuit card. The cables configured to exit the housing through the cable exit port. The ground bus is electrically connected to the cable shields and the ground plane of the circuit card. The ground bus includes a shell forming tunnels receiving the corresponding cables. The tunnels are stacked to arrange the cables in multiple rows. The shell extends between the opening at the mating end of the housing to the cable exit port at the cable end of the housing to provide shielding between the cables within the cavity of the housing.

### BACKGROUND OF THE INVENTION

The subject matter herein relates generally to electrical connectors.

Electrical connectors are typically used to electrically couple various types of electrical devices to transmit signals between the devices. At least some known cable assemblies have cables between electrical connectors, which are coupled to corresponding electrical devices. The cables each have a signal conductor, or a differential pair of signal conductors surrounded by a shield layer that, in turn, is surrounded by a cable jacket. The shield layer includes a conductive foil, which functions to shield the signal conductor(s) from electromagnetic interference (EMI) and generally improve performance. A drain wire may be provided within the cable, electrically connected to the conductive foil. At an end of the communication cable, the cable jacket, the shield layer, and insulation that covers the signal conductor(s) may be removed (e.g., stripped) to expose the signal conductor(s) and the drain wire. The exposed portions of the signal conductor(s) are then mechanically and electrically coupled (e.g., soldered) to corresponding conductors, such as signal pads of a circuit card. The exposed portions are bent and manipulated between the insulator and the signal pads on the circuit card.

However, signal integrity and electrical performance of the electrical connectors are negatively impacted at the interface between the cables and the circuit card. For example, as the signal conductors transition to the circuit card, the cable shield no longer shields the exposed portions of the signal conductors, which affects signal integrity and detrimentally affects performance. Shields may be provided to cover the ends of the cables. However, shielding effectiveness may be poor based on the shape of the shield and gaps or openings in the shield. Assembly of multiple shields to the circuit card may be time consuming and add to the overall assembly cost.

Accordingly, there is a need for an electrical connector having an improved shielded interface with a circuit card that may be manufactured and assembled in a cost effective and reliable manner.

### BRIEF DESCRIPTION OF THE INVENTION

In one embodiment, an electrical connector is provided and includes a housing that has walls forming a cavity. The housing has a cable exit port at a cable end of the housing. The housing has an opening at a mating end of the housing. The electrical connector includes a cable card assembly received in the cavity of the housing. The cable card assembly includes a circuit card, cables terminated to the circuit card, and a ground bus coupled to the circuit card. The circuit card has an array of signal pads on a surface of the circuit card. The circuit card has a ground plane. The cables include signal conductors and cable shields surrounding the corresponding signal conductors to provide electrical shielding for the signal conductors. The signal conductors are electrically connected to corresponding signal pads of the circuit card. The cables configured to exit the housing through the cable exit port. The ground bus is electrically connected to the cable shields of the cables. The ground bus is electrically connected to the ground plane of the circuit card. The ground bus includes a shell forming tunnels receiving the corresponding cables. The tunnels are stacked to arrange the cables in multiple rows. The shell extends between the opening at the mating end of the housing to the cable exit port at the cable end of the housing to provide shielding between the cables within the cavity of the housing.

In another embodiment, an electrical connector is provided and includes a housing that has walls forming a cavity. The housing has a cable exit port at a cable end of the housing. The housing has an opening at a mating end of the housing. The housing includes mounting tab pockets at the mating end. The electrical connector includes mounting tabs received in the mounting tab pockets. The mounting tabs include compliant pins protruding from the mating end of the housing. The electrical connector includes a cable card assembly received in the cavity of the housing. The cable card assembly includes a circuit card, cables terminated to the circuit card, and a ground bus coupled to the circuit card. The circuit card has an array of signal pads on a surface of the circuit card. The circuit card has a ground plane. The circuit card includes vias. The compliant pins are press fit into the vias to secure the housing to the circuit card. The cables include signal conductors and cable shields surrounding the corresponding signal conductors to provide electrical shielding for the signal conductors. The signal conductors are electrically connected to corresponding signal pads of the circuit card. The cables configured to exit the housing through the cable exit port. The ground bus is electrically connected to the cable shields of the cables. The ground bus is electrically connected to the ground plane of the circuit card. The ground bus includes a shell forming tunnels receiving the corresponding cables.

In a further embodiment, a communication system is provided and includes a socket connector that includes a receptacle housing having sidewalls forming a socket with an opening to the socket. The socket connector includes a socket substrate that includes socket contacts. The socket contacts include mating ends. The communication system includes an electrical connector received in the socket through the opening and is mated with the mating ends of the socket contacts. The electrical connector includes a housing holding a cable card assembly. The housing has walls forming a cavity, a cable exit port at a cable end of the housing, and an opening at a mating end of the housing. The housing is coupled to the socket connector. The cable card assembly includes a circuit card, cables terminated to the circuit card, and a ground bus coupled to the circuit card. The circuit card has a first array of signal pads on a first surface of the circuit card. The circuit card has a second array of signal contacts on a second surface of the circuit card is mated with mating ends of the corresponding socket contacts. The cables include signal conductors and cable shields surrounding the corresponding signal conductors to provide electrical shielding for the signal conductors. The signal conductors are electrically connected to corresponding signal pads of the circuit card. The cables configured to exit the housing through the cable exit port. The ground bus is electrically connected to the cable shields of the cables. The ground bus is electrically connected to a ground plane of the circuit card. The ground bus includes a shell forming tunnels receiving the corresponding cables. The tunnels are stacked to arrange the cables in multiple rows. The shell extends between the opening at the mating end of the housing to the cable exit port at the cable end of the housing to provide shielding between the cables within the cavity of the housing.

### BRIEF DESCRIPTION OF THE DRAWINGS

FIG. 1 is a perspective view of a communication system in accordance with an exemplary embodiment.

FIG. 2 is a perspective view of the communication system with the mounting clip removed to illustrate the components of the second electrical connector in accordance with an exemplary embodiment.

FIG. 3 is a perspective view of the first electrical connector in accordance with an exemplary embodiment.

FIG. 4 is a perspective view of the cable card assembly in accordance with an exemplary embodiment.

FIG. 5 is a side view of the mounting tab in accordance with an exemplary embodiment.

FIG. 6 is a bottom perspective view of a portion of the first electrical connector showing the housing and the mounting tabs coupled to the housing in accordance with an exemplary embodiment.

FIG. 7 is a partial sectional view of a portion of the first electrical connector in accordance with an exemplary embodiment.

FIG. 8 is a sectional view of a portion of the first electrical connector in accordance with an exemplary embodiment.

FIG. 9 is a sectional view of a portion of the first electrical connector in accordance with an exemplary embodiment.

FIG. 10 is a cross-sectional view of the communication system in accordance with an exemplary embodiment showing the first electrical connector mated with the second electrical connector.

FIG. 11 is a top perspective view of a portion of the ground bus showing the inner bus member in accordance with an exemplary embodiment.

FIG. 12 is a top perspective view of a portion of the ground bus showing one of the outer bus members coupled to the inner bus member in accordance with an exemplary embodiment.

FIG. 13 is a top perspective view of a portion of the ground bus showing one of the outer bus members coupled to the inner bus member in accordance with an exemplary embodiment.

FIG. 14 is a top perspective view of a portion of the ground bus showing one of the outer bus members with cables arranged along the outer bus member in accordance with an exemplary embodiment.

FIG. 15 is a top perspective view of a portion of the ground bus showing a plurality of the outer bus members coupled to the inner bus member in accordance with an exemplary embodiment.

### DETAILED DESCRIPTION OF THE INVENTION

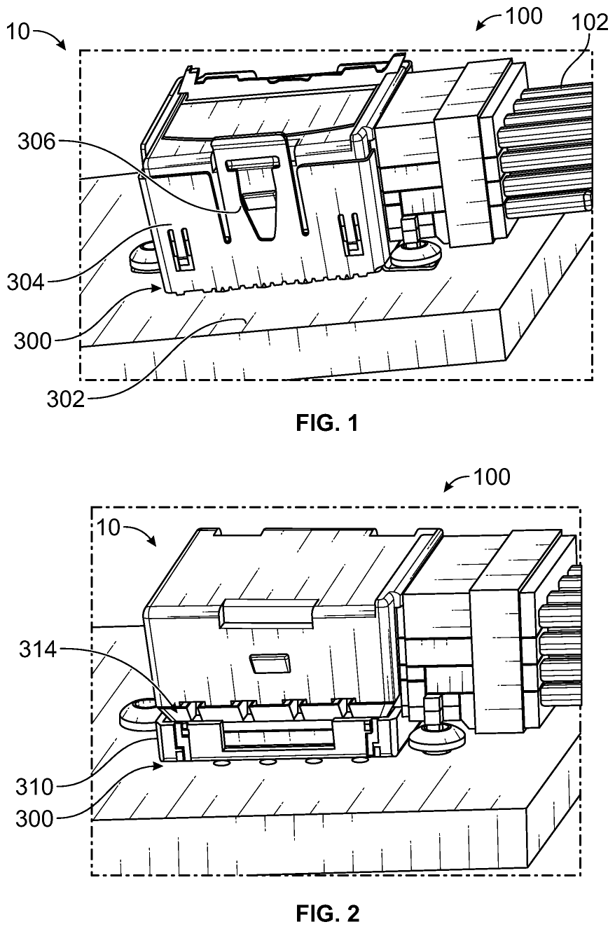

FIG. 1 is a perspective view of a communication system 10 in accordance with an exemplary embodiment. The communication system 10 includes a first electrical connector 100 provided at ends of cables 102 and a second electrical connector 300. In the illustrated embodiment, the second electrical connector 300 is mounted to a circuit board 302. In other various embodiments, the second electrical connector 300 may be provided at ends of cables (not shown).

The connectors 100, 300 may be input-output (I/O) connectors. In an exemplary embodiment, the second electrical connector 300 is a receptacle connector. The second electrical connector 300 may be a socket connector, such as a header connector. In other embodiments, the second electrical connector 300 may be a card edge connector having a card slot. The first electrical connector 100 is mated to the second electrical connector 300 at a separable interface. In an exemplary embodiment, the first electrical connector 100 is a plug connector configured to be pluggably coupled to the second electrical connector 300. For example, a portion of the first electrical connector 100 may be plugged into a receptacle or opening or slot of the second electrical connector 300. In an exemplary embodiment, the first electrical connector 100 is coupled to the second electrical connector 300 at a separable interface. For example, the first electrical connector 100 is latchably coupled to the second electrical connector 300 using a mounting clip 304 having latching elements 306 holding a pressure plate 308 at the top of the mounting clip 304. The pressure plate 308 is configured to press the first electrical connector 100 into the socket. The latching elements 306 hold down the pressure plate 308 against the first electrical connector 100. The latching elements 306 may be directly latched to the first electrical connector 100 in alternative embodiments. The latching elements 306 may be releasable to allow removal of the first electrical connector 100 from the second electrical connector 300.

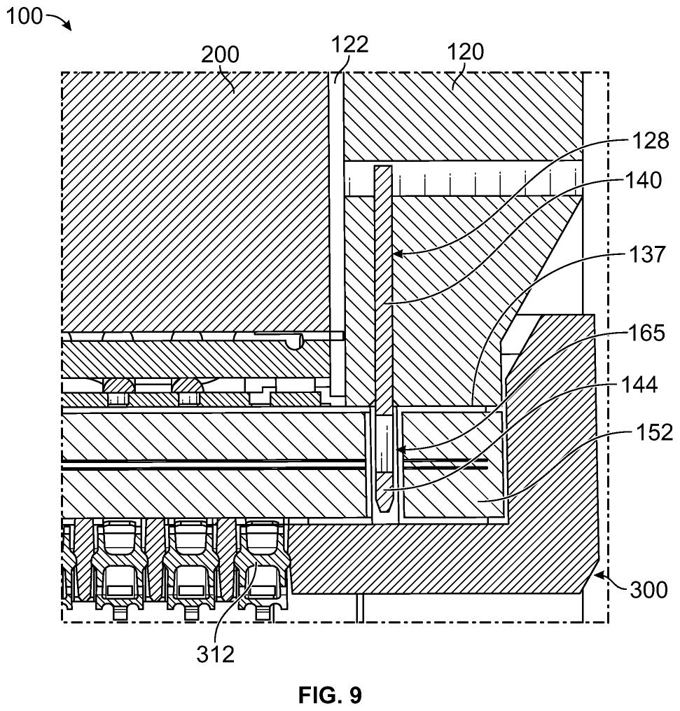

With additional reference to FIG. 2, which is a perspective view of the communication system 10 with the mounting clip 304 removed to illustrate the components of the second electrical connector 300, the second electrical connector 300 includes a receptacle housing 310 holding an array of contacts 312 (shown in FIGS. 8 and 9). In an exemplary embodiment, the receptacle housing 310 includes an opening 314 that receives the first electrical connector 100. The opening 314 may be a socket configured to receive the plug end of the first electrical connector 100. The opening 314 may be a card slot in alternative embodiments. The opening 314 is located at the top of the receptacle housing 310 in the illustrated embodiment. Other locations are possible in alternative embodiments, such as at the front. The contacts 312 have separable mating interfaces. The contacts 312 may define a compressible interface, such as including deflectable spring beams that are compressed when the first electrical connector 100 is received in the opening 314. Optionally, the contacts 312 may be arranged in multiple rows and columns. In various embodiments, the contacts 312 are a land grid array (LGA). In various embodiments, the second electrical connector 300 is a communication device, such as a socket connector. The second electrical connector 300 may be a high-speed connector.

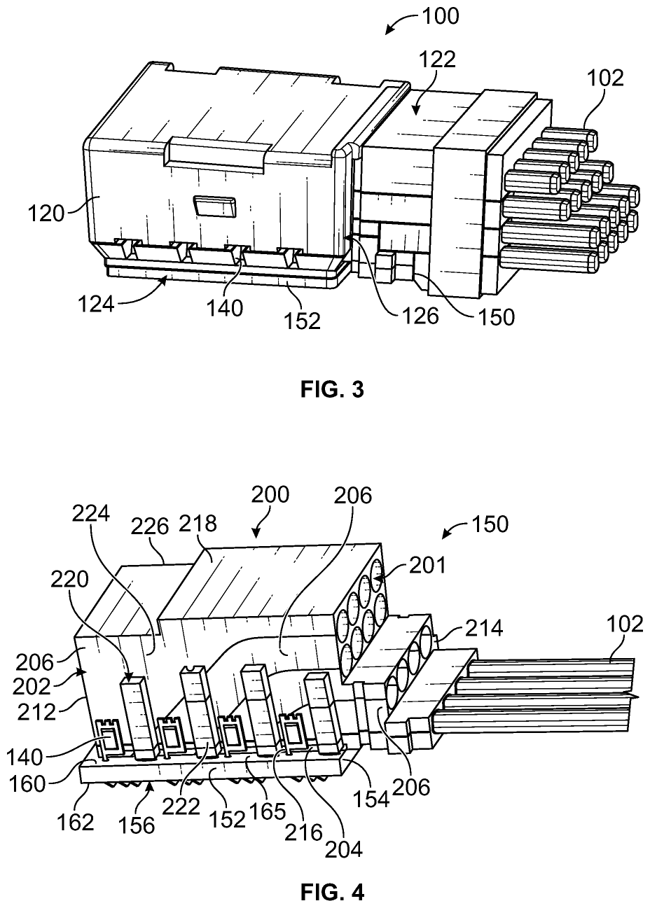

With additional reference to FIG. 3, which is a perspective view of the first electrical connector 100, the first electrical connector 100 includes a housing 120 having a cavity 122 that receives a cable card assembly 150. The first electrical connector 100 has a cable end 124 and a mating end 126 opposite the cable end 124. The cables 102 extend from the cable end 124. The mating end 126 is configured to be coupled to the second electrical connector 300. In the illustrated embodiment, the first electrical connector 100 is a right angle connector. For example, the cable end 124 is at the rear of the housing 120 and the mating end 126 is at the bottom of the housing 120. Other locations are possible in alternative embodiments, such as having the mating end 126 at the front or having the cable end 124 at the top. The cable card assembly 150 includes a circuit card 152. The cables 102 are configured to be terminated to the circuit card 152. In an exemplary embodiment, the housing 120 is configured to be mounted to the circuit card 152. For example, the bottom of the housing 120 may be mounted to the upper surface of the circuit card 152. In an exemplary embodiment, the housing 120 is coupled to the circuit card 152 using mounting tabs 140

The circuit card 152 is configured to be plugged into the opening 314 of the second electrical connector 300 when the first electrical connector 100 is mated with the second electrical connector 300. In the illustrated embodiment, the circuit card 152 is provided at the bottom of the first electrical connector 100 and the bottom of the circuit card 152 is mated with the contacts 312 of the second electrical connector 300. For example, the entire circuit card 152 is received in the opening 314 and mated with the contacts 312. However, in alternative embodiments, only a portion of the circuit card 152 may be plugged into the receptacle housing 310. For example, the circuit card 152 may include a card edge that is plugged into a card slot at a front of the receptacle housing 310.

FIG. 4 is a perspective view of the cable card assembly 150 in accordance with an exemplary embodiment. The cable card assembly 150 includes the circuit card 152, the cables 102 connected to the circuit card 152, and a ground bus 200 separate and discrete from the circuit card 152 and coupled to the circuit card 152. The ground bus 200 provides shielding for the ends of the cables 102 at the interface between the cables 102 and the circuit card 152. Optionally, the signal conductors of the cables 102 may be terminated directly to the circuit card 152. Alternatively, a contact assembly (for example, stamped and formed contacts and/or overmolded leadframe(s)) may be provided to electrically connect the signal conductors of the cables 102 to the circuit card 152. The ground bus 200 is electrically coupled to the cables 102, such as cables shields and/or drain wires of the cables 102. The ground bus 200 is electrically coupled to the circuit card 152. For example, the ground bus 200 is electrically connected to circuits or conductors of the circuit card 152, such as to a ground plane and/or ground pads of the circuit card 152.

The ground bus 200 provides electrical shielding for the signal conductors of the cables 102 and the circuit conductors of the circuit card 152. The ground bus 200 is electrically connected to the shield structures of the cables 102, such as to cable shields of the cables 102 and/or drain wires of the cables 102. In an exemplary embodiment, the ground bus 200 is connected to the cable shields and/or the drain wires using a conductive gasket, conductive adhesive, conductive epoxy, a conductive tape or braid, conductive foam, soldering, and the like. In an exemplary embodiment, the ground bus 200 is soldered to the circuit card 152. For example, solder posts or solder tabs are provided at the bottom of the ground bus 200 for soldering to the circuit card 152 at termination areas. In various embodiments, multiple ground busses 200 may be provided.

In an exemplary embodiment, the cable card assembly 150 includes multiple rows and multiple columns of cables 102. The cables 102 may be grouped together, such as in 2×4 arrangements. In the illustrated embodiment, the cables 102 are terminated to one side of the circuit card 152, such as the top side of the circuit card 152. However, the cables 102 may additionally or alternatively be terminated to the bottom side of the circuit card 152. Each row of cables 102 includes the corresponding ground bus 200. The ground busses 200 may be similar for each of the rows. However, the ground busses 200 may be sized and shaped differently to accommodate a stacking/overlapping situation.

The circuit card 152 extends between a cable end 154 (for example, top portion) and a mating end 156 (for example, bottom portion). Other arrangements are possible in alternative embodiments, such as having the mating end 156 at a front edge of the circuit card 152 to plug into a card slot. The cable end 154 may additionally or alternatively be provided at the bottom portion in other alternative embodiments. The cables 102 are configured to be coupled to the circuit card 152 at the cable end 154. The cables 102 extend rearward from the circuit card 152 in the illustrated embodiment. The circuit card 152 includes an upper surface 160 and a lower surface 162. The cables 102 are connected to the circuit card 152 at the upper surface 160 in the illustrated embodiment. The lower surface 162 is configured to be mated to the second electrical connector 300 in the illustrated embodiment.

The circuit card 152 includes circuit conductors 164 (shown in FIG. 7), such as mating pads, traces, vias, and the like. The circuit conductors 164 may be provided at both the upper surface 160 and the lower surface 162. The circuit conductors 164 may include both signal conductors and ground conductors of the circuit card 152. In an exemplary embodiment, the circuit conductors 164 are provided at the cable end 154 for connection to the cables 102 (and/or the contact assembly) and at the mating end 156 for connection to the second electrical connector 300. The circuit conductors 164 at the mating end 156 define mating conductors configured to be electrically connected to corresponding contacts 312 (shown in FIG. 9) of the second electrical connector 300. The circuit conductors 164 at the cable end 154 are configured to be electrically connected to the signal conductors of the cables 102 and the ground bus 200. The circuit conductors 164 may be arranged in pairs corresponding to differential pairs of signal paths, which may be surrounded by ground conductors for shielding.

The ground bus 200 surrounds the ends of the cables 102 to provide electrical shielding for the cables 102, such as at the ends of the cables 102. For example, the ends of the cables 102 are located in corresponding tunnels 201 in the ground bus 200. The ground bus 200 is three-dimensional. The ground bus 200 is configured to surround all sides of the ends of the cables 102 (for example, the cable top, the cable bottom, the cable right side and the cable left side). The ground bus 200 is electrically connected to the cables 102 (for example, the cable shield and/or drain wires). In an exemplary embodiment, the ground bus 200 is configured to engage and electrically connect to the cable shield of the cable on all sides (for example, the top, the bottom, the right side and the left side). The ground bus 200 is terminated to the circuit card 152. The ground bus 200 electrically commons the cables 102 with the circuit card 152. The ground bus 200 electrically commons the cables 102 with each other. The ground bus 200 provides electrical shielding for signals transmitted between the circuit card 152 and the cables 102. The ground bus 200 enhances electrical performance of the cable card assembly 150, such as by reducing cross talk.

The ground bus 200 includes a shell 202 manufactured from a conductive material, such as a metal material to provide electrical shielding. In various embodiments, the ground bus 200 may be a diecast component. In other various embodiments, the ground bus 200 may be a plated plastic or conductive polymer structure. In other various embodiments, the ground bus 200 may be a stamped and formed component. In an exemplary embodiment, the ground bus 200 is a multipiece structure. For example, the ground bus 200 includes one or more inner bus members 204 and one or more outer bus members 206 coupled to the inner bus member(s) 204. For example, a plurality of outer bus members 206 may be stacked on the inner bus member 204 to form a stacked bus. Optionally, one or more conductive gaskets may be provided at the interface(s) between the inner bus member(s) 204 and the outer bus member(s) 206. The inner bus member 204 is located between the outer bus members 206 and the circuit card 152. The ground bus 200 may be oriented such that the inner bus member 204 is a bottom bus member and the outer bus member(s) 206 are intermediate bus members or a top bus member. However, other orientations are possible in alternative embodiments. The cables 102 are received between the bus members 204, 206. For example, the tunnels 201 may be formed by the inner and outer bus members 204, 206 and the cables 102 are received in the tunnels 201 between the inner and outer bus members 204, 206.

The ground bus 200 extends between a front 212 and a rear 214. The cables 102 are configured to exit the ground bus 200 at the rear 214. Optionally, the rear 214 may be stepped at different distances from the front 212. For example, the ground bus 200 may be longer at the bottom to provide sufficient shielding coverage for the innermost row of cables 102 and shorter at the top because the cables extend closer to the front 212 to provide sufficient shielding coverage for the outermost row of cables 102. In an exemplary embodiment, the ground bus 200 may extend rearward of the rear edge of the circuit card 152. For example, the rear 214 may be located rearward of the rear edge of the circuit card 152.

The ground bus 200 extends between an inner end 216 and an outer end 218. The inner bus member 204 is at the inner end 216 and the outer bus member 206 is at the outer end 218. The ground bus 200 may be oriented such that the inner end 216 is a bottom end and the outer end 218 is a top end. However, other orientations are possible in alternative embodiments. In an exemplary embodiment, the inner end 216 is at the bottom and faces the circuit card 152. The inner end 216 may be mounted to the circuit card 152 to mechanically and electrically connect the ground bus 200 to the circuit card 152. In an exemplary embodiment, the inner end 216 is configured to be soldered to the circuit card 152.

In an exemplary embodiment, the ground bus 200 includes locating elements 220 for locating the ground bus 200 in the housing 120 (FIG. 3). The locating elements 220 may be tabs or rails 222 extending from sides 224, 226 of the ground bus 200. The rails 222 may be received in slots or channels in the housing 120. In an exemplary embodiment, each of the bus members 204, 206 include rails 222, which may be aligned with each other to align the bus members 204, 206 with each other.

In an exemplary embodiment, the circuit card 152 includes vias 165. The vias 165 may be plated vias, which may be electrically connected to the ground plane of the circuit card 152. In an exemplary embodiment, the mounting tabs 140 may be received in the vias 165. For example, the mounting tabs 140 may be press fit into the vias 165. The vias 165 may extend along the sides of the ground bus 200.

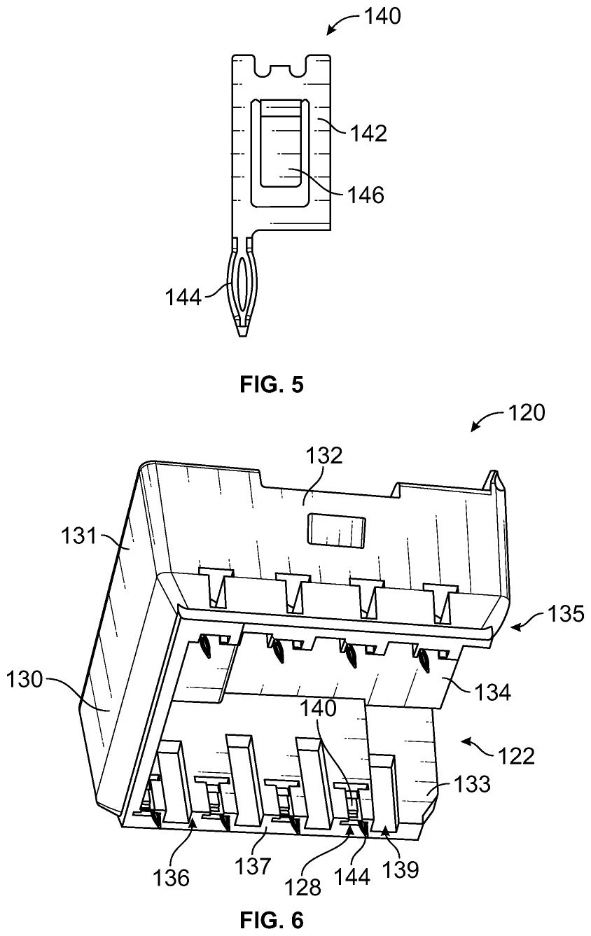

FIG. 5 is a side view of the mounting tab 140 in accordance with an exemplary embodiment. The mounting tab 140 includes a main body 142 and a compliant pin 144 extending from the main body 142. In an exemplary embodiment, the mounting tab 140 includes a locking lance 146 extending from the main body 142. The locking lance 146 is used to secure the mounting tab 140 in the housing 120. In an exemplary embodiment, the mounting tab 140 is stamped and formed. The main body 142 may be planar. In the illustrated embodiment, the main body 142 is generally rectangular. However, the main body 142 may have other shapes in alternative embodiments.

The compliant pin 144 is located at the bottom. The compliant pin may be offset from the center, such as located proximate to one of the sides. The compliant pin 144 is configured to be press fit into the circuit card 152, such as into the via 165. For example, the compliant pin 144 includes an opening flanked by compliant beams. The compliant beams are configured to be deformed, such as pressed inward, when the compliant pin 144 is pressed into the via 165. The compliant pin 144 extends a pin distance from the bottom of the main body 142. The compliant pin 144 may be short, such as less than the thickness of the circuit card 152. In various embodiments, the pin distance of the compliant pin 144 is less than 1.0 mm.

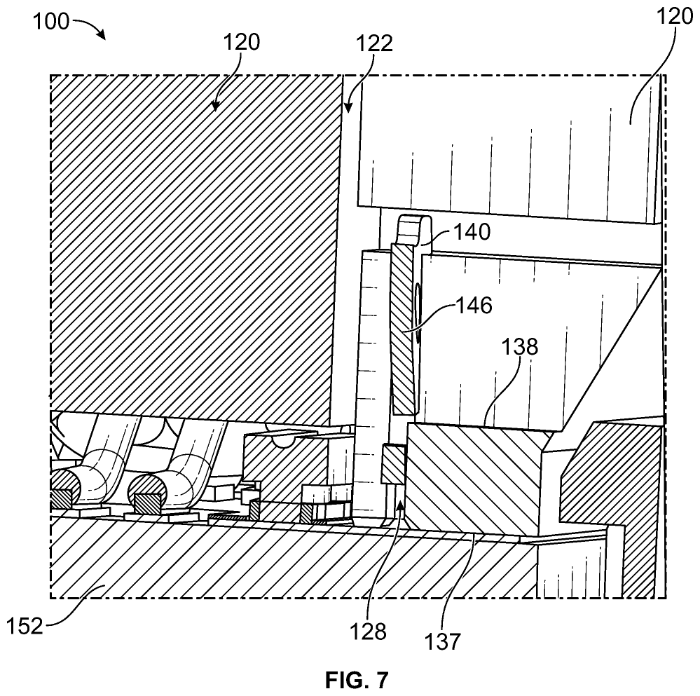

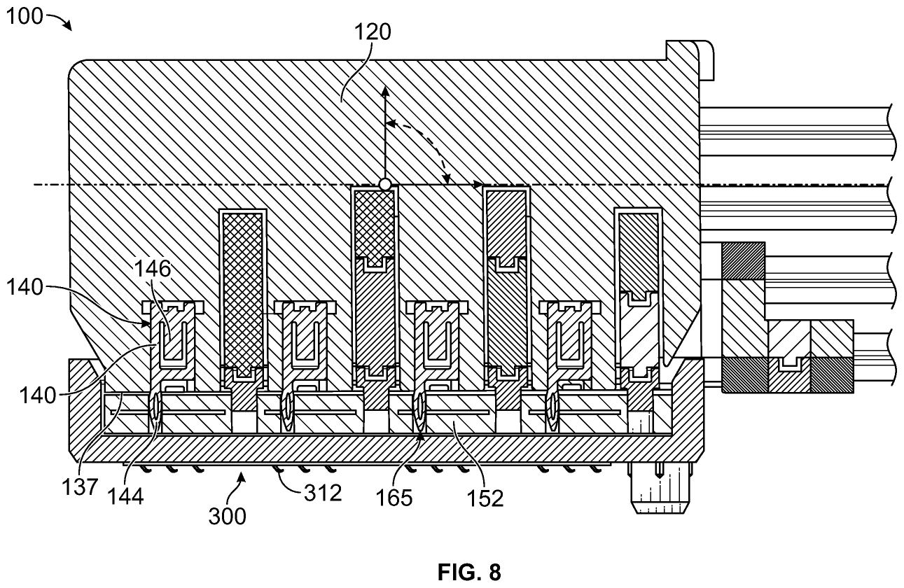

FIG. 6 is a bottom perspective view of a portion of the first electrical connector 100 showing the housing 120 and the mounting tabs 140 coupled to the housing 120. The mounting tabs 140 are received in mounting tab pockets 128 in the housing 120. The compliant pins 144 of the mounting tabs 140 protrude from the housing 120 for connection to the circuit card 152 (shown in FIG. 4).

The housing 120 includes a plurality of walls 130 forming the cavity 122. For example, the housing 120 includes a front wall 131, side walls 132, 133, and a top wall 134. In an exemplary embodiment, the housing 120 includes a cable exit port 135 at a rear of the housing 120. The cable exit port 135 is located between the side walls 132, 133. The cable exit port 135 is located below the top wall 134. The cables 102 (shown in FIG. 4) are configured exit the cavity 122 through the cable exit port 135. In an exemplary embodiment, the housing 120 includes an opening 136 at a bottom of the housing 120. The opening 136 is located between the side walls 132, 133. The opening 136 is located rearward of the front wall 131. In an exemplary embodiment, the cable card assembly 150 (shown in FIG. 4) is configured to be loaded into the cavity 122 through the opening 136. For example, the housing 120 may be lowered onto the cable card assembly 150 with the cable card assembly 150 passing through the opening 136. The housing 120 may include additional walls 130 in alternative embodiments, such as a bottom wall and/or a rear wall. The cable exit port 135 and/or the opening 136 may be located at other locations in alternative embodiments, such as at the front and/or at the top, and/or at the sides of the housing 120.

In an exemplary embodiment, the housing 120 includes a bottom edge 137 at the bottom of the housing 120. The bottom edge 137 is defined by the walls 130, such as the front wall 131 and the side walls 132, 133. The bottom edge 137 is configured to face the circuit card 152. For example, the bottom edge 137 may be seated on the circuit card 152 when the first electrical connector 100 is assembled. The mounting tab pockets 128 are open at the bottom edge 137. The mounting tabs 140 may be loaded into the mounting tab pockets 128 through the bottom edge 137. The compliant pins 144 protrude downward from the bottom edge 137.

In an exemplary embodiment, the housing 120 includes locating grooves 139 along the side walls 132, 133. The locating grooves 139 are configured to receive the locating elements 220 of the ground bus 200 (shown in FIG. 4). Optionally, multiple locating grooves 139 may be provided on each of the side walls 132, 133. Other types of locating features may be used in alternative embodiments to locate the housing 120 relative to the ground bus 200.

FIG. 7 is a partial sectional view of a portion of the first electrical connector 100 in accordance with an exemplary embodiment. FIG. 8 is a sectional view of a portion of the first electrical connector 100 in accordance with an exemplary embodiment. FIG. 9 is a sectional view of a portion of the first electrical connector 100 in accordance with an exemplary embodiment. FIGS. 7-9 show the mounting tabs 140 in the mounting tab pockets 128. Each mounting tab 140 is coupled to the housing 120. In an exemplary embodiment, the housing 120 includes a locking shoulder 138 and the mounting tab pocket 128. The locking lance 146 is configured to engage the locking shoulder 138 to secure the mounting tab 140 in the housing 120.

When assembled, the housing 120 is coupled to the ground bus 200. For example, the ground bus 200 is received in the cavity 122. The housing 120 is coupled to the circuit card 152. For example, the bottom edge 137 is seated on the upper surface of the circuit card 152. The compliant pins 144 are received in corresponding vias 165 in the circuit card 152. The compliant pins 144 are press-fit into the vias 165. In an exemplary embodiment, the compliant pins 144 have short pin lengths such that the compliant pins 144 do not protrude beyond the bottom of the circuit card 152. Rather, the circuit card 152 has a thickness greater than the pin lengths of the compliant pins 144. As such, the compliant pins 144 do not stub or interfere with the socket connector of the second electrical connector 300 when the first electrical connector 100 is mated with the second electrical connector 300. The circuit card 152 is able to be fully plugged into the socket of the socket connector without the compliant pins 144 bottoming out on the second electrical connector 300 thus preventing full mating of the circuit card 152 with the contacts 312 of the second electrical connector 300.

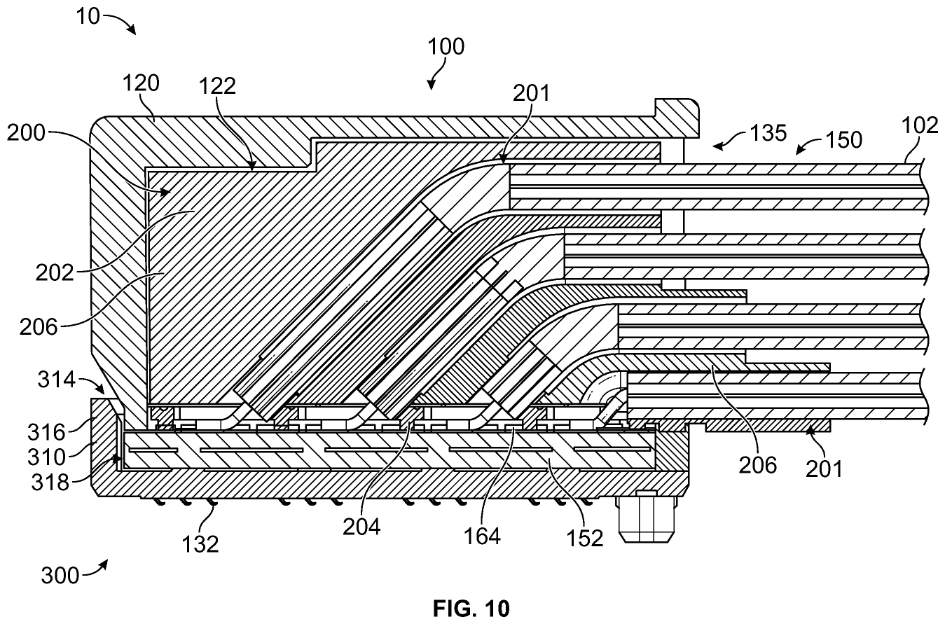

FIG. 10 is a cross-sectional view of the communication system 10 in accordance with an exemplary embodiment showing the first electrical connector 100 mated with the second electrical connector 300. The second electrical connector 300 is illustrated as a socket connector. The receptacle housing 310 includes walls 316 forming a receptacle or socket 318 that receives the first electrical connector 100. The receptacle housing 310 holds the contacts 312 in the socket 318 for mating with the circuit card 152 of the cable card assembly 150. The circuit card 152 may be plugged into the socket 318 through the opening 314 at the top of the receptacle housing 310.

The cables 102 are electrically connected to the contacts 312 of the second electrical connector 300 through the circuit card 152. For example, the conductors of the cables 102 may be soldered to the circuit conductors 164 of the circuit card 152, which pass through the circuit card 152 between the upper surface and the lower surface to mate with the contacts 312 of the second electrical connector 300. In an exemplary embodiment, the contacts 312 are deflectable to form a compressible interface with the socket connector.

The ground bus 200 receives the cables 102. For example, the cables 102 are received in corresponding tunnels 201 in the ground bus 200. The cables 102 are supported by the ground bus 200 and the tunnels 201. For example, the ground bus 200 forms cable cradles within the tunnels 201 that receive and support the cables 102. The ground bus 200 provides electrical shielding along the cables 102. In an exemplary embodiment, the ground bus 200 extends a sufficient cable length of the cables 102 to provide effective shielding along end segments of the cables 102. In an exemplary embodiment, the ground bus 200 extends a shield length that is at least five times the diameter of the cable 102. In an exemplary embodiment, the ground bus 200 extends generally from the circuit card 152 to a location at or beyond the cable exit port 135 to ensure electrical shielding for each of the cables 102 within the cavity 122 of the housing 120. In various embodiments, the ground bus 200 may extend to the exterior of the housing 120, such as rearward of the cable exit port 135.

In an exemplary embodiment, the shell 202 of the ground bus 200 is manufactured from a conductive material, such as a metal material to provide electrical shielding. In an exemplary embodiment, the ground bus 200 is a multipiece structure including the inner bus member 204 and one or more outer bus members 206 coupled to the inner bus member 204. For example, the outer bus members 206 may be stacked on the inner bus member 204 and/or stacked on each other to form a stacked bus. The inner bus member 204 is at a bottom of the ground bus 200. The inner bus member 204 is configured to be mounted to the circuit card 152. The outer bus members 206 are stacked on the inner bus member 204, such as to receive different rows of the cables 102. Some of the outer bus members 206 may receive rows of the cables 102 on both sides of the outer bus member 206 (for example, the inner side and the outer side of such outer bus member 206).

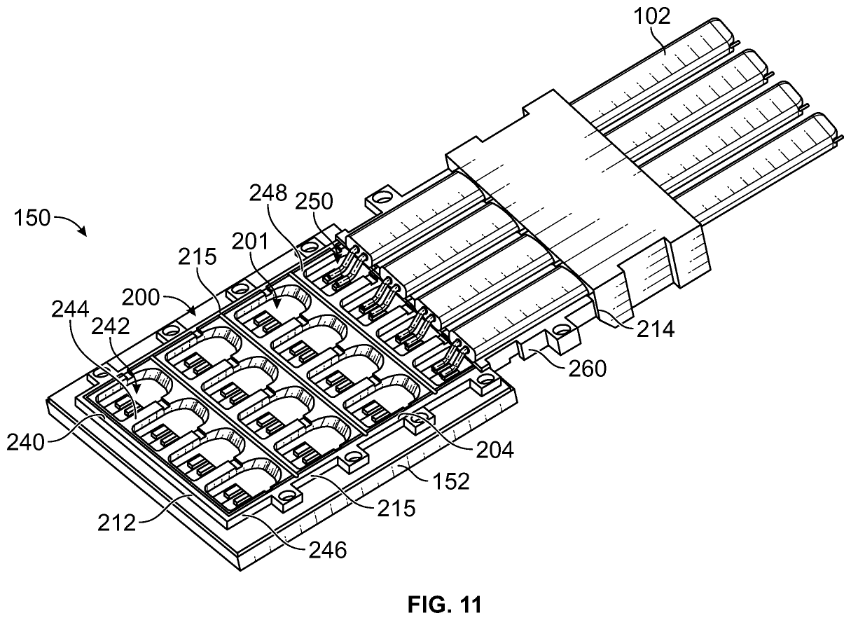

FIG. 11 is a top perspective view of a portion of the ground bus 200 showing the inner bus member 204 in accordance with an exemplary embodiment. The inner bus member 204 is manufactured from a conductive material, such as a metal material. In various embodiments, the inner bus member 204 is a diecast member. In other various embodiments, the inner bus member 204 may be a plated plastic member. In the illustrated embodiment, the inner bus member 204 is shown as a single unit between the front 212 and the rear 214 configured to accommodate multiple rows of the cables 102. However, in alternative embodiments, the inner bus member 204 may be a multi-piece structure, such as including a stack of bus elements arranged front to rear to accommodate corresponding rows of the cables 102.

The inner bus member 204 includes a base 240 extending between the front 212 and the rear 214. The base 240 includes sides 215 that extend between the front 212 and the rear 214. In an exemplary embodiment, the base 240 includes a plurality of openings 242 therethrough. The openings 242 form portions of the tunnels 201. The base 240 includes separating walls 244 between the openings 242/tunnels 201. The separating walls 244 surround the tunnels 201. For example, the separating walls 244 extend along both sides of the tunnels 201, extend along the fronts of the tunnels 201 and extend along the rears of the tunnels 201. The separating walls 244 provide shielding between the tunnels 201. The separating walls 244 of the inner bus member 204 extend between a bottom or a lower surface 246 and a top or an upper surface 248. The lower surface 246 is configured to face the circuit card 152. The outer bus members 206 (FIG. 10) are configured to be coupled to the inner bus member 204 at the upper surface 248. Optionally, conductive gaskets may be provided at the upper surface 248.

In an exemplary embodiment, the base 240 includes cable cradles 250 configured to receive corresponding cables 102. The cable cradles 250 form portions of the tunnels 201. The cable cradles 250 support the cables 102 for termination to the circuit card 152. The cable cradles 250 define cable exit paths and control the cable exit directions for the cables 102. For example, the cable exit direction may be upward and rearward from the base 240, such as to elevate the cables 102 over the rearward rows of cables. In various embodiments, the cable exit direction may be approximately 45°. The cable cradles 250 provide support for the cables 102, such as to provide strain relief for the cables 102. The cable cradles 250 may form an area for electrical connection to the cable shield of the cable 102, such as along the bottom and sides of the cable shield.

In an exemplary embodiment, the inner bus member 204 includes a rear support wall 260 at the rear of the inner bus member 204. The rear support wall 260 is located rearward of the rear row of tunnels 201. The rear support wall 260 supports the cables 102 associated with the rear row of tunnels 201. The cable cradles 250 extend along the upper surface of the rear support wall 260 to receive the cables 102. Because the rear support wall 260 is used to support the cables 102 associated with the rear row of tunnels 201, which are the shortest cables 102 within the cable card assembly 150, the rear support wall 260 extends rearward of the tunnels 201 by a sufficient distance to provide efficient support and shielding for the cables 102. For example, the rear support wall 260 may extend at least twice a length of the openings 242. The rear support wall 260 may extend at least 25% of a total length of the inner bus member 204.

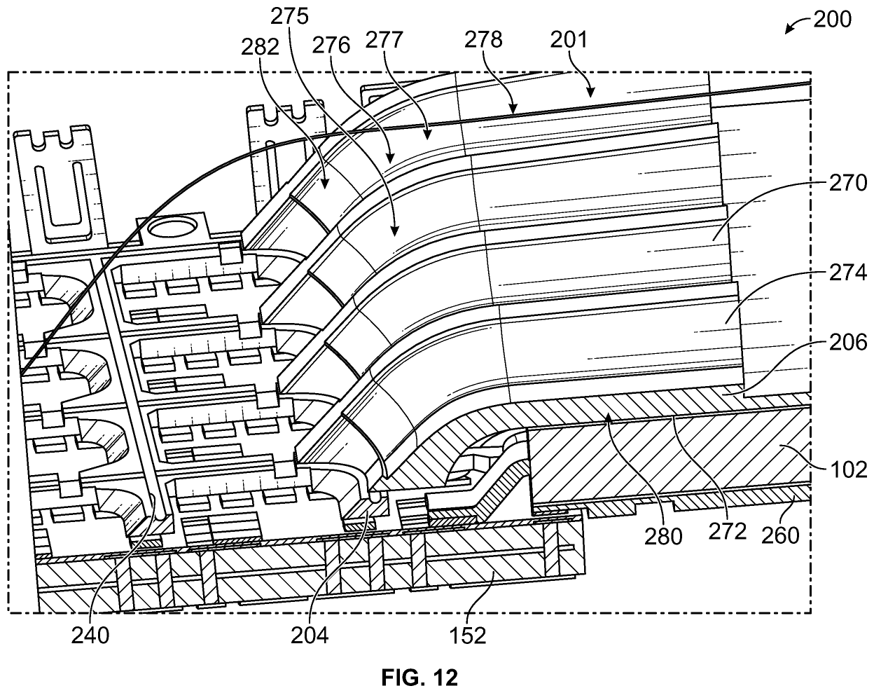

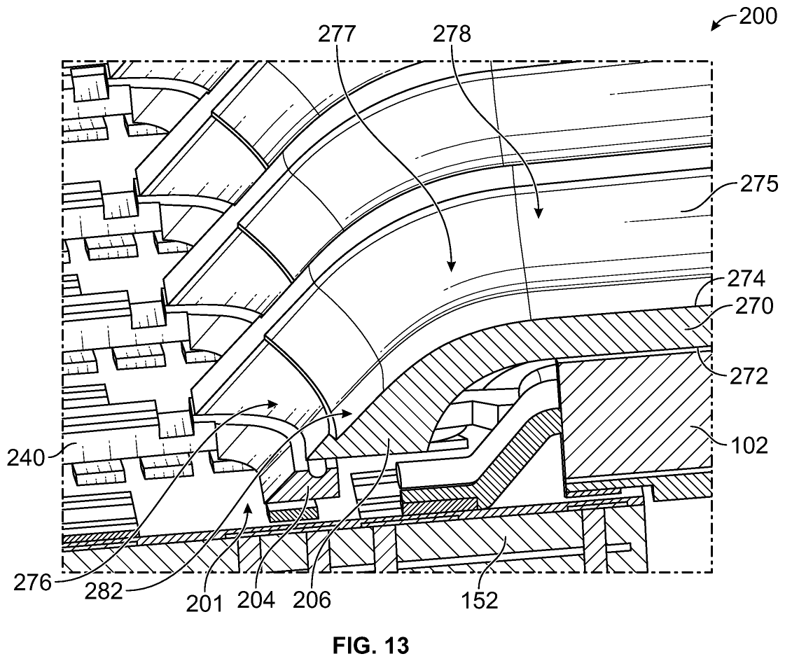

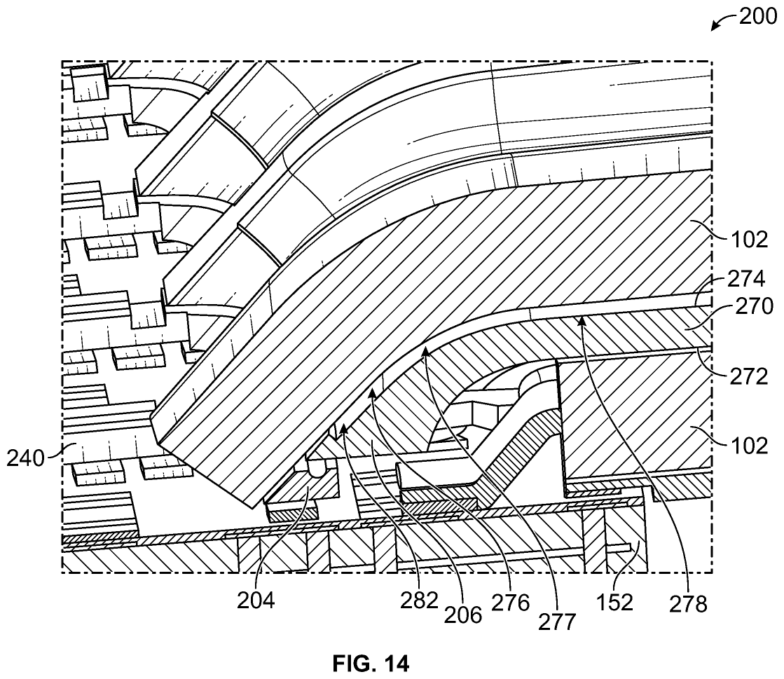

FIG. 12 is a top perspective view of a portion of the ground bus 200 showing one of the outer bus members 206 coupled to the inner bus member 204 in accordance with an exemplary embodiment. FIG. 13 is a top perspective view of a portion of the ground bus 200 showing one of the outer bus members 206 coupled to the inner bus member 204 in accordance with an exemplary embodiment. FIG. 14 is a top perspective view of a portion of the ground bus 200 showing one of the outer bus members 206 with cables 102 arranged along the outer bus member 206. The first outer bus member 206 (for example, outer bus member 206 closest to the rear and/or closest to the circuit card 152) extends between a front and a rear. The outer bus member 206 is manufactured from a conductive material, such as a metal material. In various embodiments, the outer bus member 206 is a diecast member. In other various embodiments, the outer bus member 206 may be stamped and formed or a plated plastic member. The outer bus member 206 is configured to provide shielding for the cables 102.

The outer bus member 206 includes a central wall 270 having an inner surface 272 and an outer surface 274. The central wall 270 separates two rows of the cables 102 from each other. The central wall 270 includes the cable cradles 275 along the inner surface 272 and the outer surface 274 to receive two different rows of the cables 102. In an exemplary embodiment, the central wall 270 includes a first segment 276 and a second segment 278. The first segment 276 is located at the front. The second segment 278 is at the rear. The central wall 270 includes a transition 277 between the first segment 276 and the second segment 278. The transition 277 may be curved to control curvature or bending of the cable 102 along the central wall 270. In an exemplary embodiment, the first segment 276 is angled relative to the second segment 278 to accommodate the cables 102 extending between the bottom and the rear of the ground bus 200. For example, the second segment 278 may be oriented horizontally and the first segment 276 is angled from the transition 277 to the base 240 of the first bus member 204 at the bottom, such as at an angle between 30° and 60°. The first segment 276 allows the cables 102 along the inner surface 272 to lift upward off of the circuit card 152 to an elevation allowing the cables 102 to pass over the rearward row of cables 102.

In an exemplary embodiment, the outer bus member 206 may include a rear support wall 280, similar to the rear support wall 260 of the inner bus member 204. The rear support wall 280 may be shorter than the rear support wall 260 because the first and second segments 276, 278 cover a greater length of the cables 102 between the circuit card 152 and the cable exit port. Optionally, the rear support wall 260 of the inner bus member 204 may have a similar length as the central wall 270 and the rear support wall 280 of the first outer bus member 206.

In an exemplary embodiment, the central wall 270 of the outer bus member 206 includes clearance channels 282 in the tunnels 201 along the cable cradles 275. The clearance channels 282 oversize the tunnels 201 relative to the cables 102. The clearance channels 282 provide a clearance gap in the tunnels 201 to accommodate bending of the cables 102 in the tunnels 201, such as at the transition 277, to prevent buckling of the cable jacket. The clearance channels 282 may increase the volume of the tunnels 201 by approximately 10% or more.

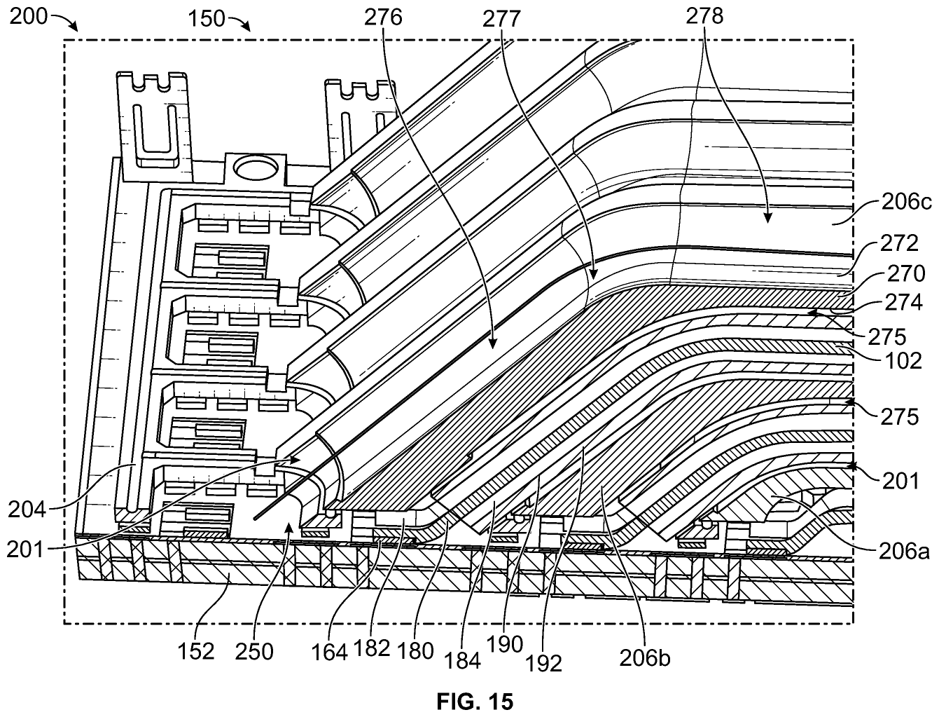

FIG. 15 is a top perspective view of a portion of the ground bus 200 showing a plurality of the outer bus members 206 coupled to the inner bus member 204 in accordance with an exemplary embodiment. For example, FIG. 15 shows the first outer bus member 206a, the second outer bus member 206b, and the third outer bus member 206c arranged from rear to front and/or from the inner bus member 204 outward.

The outer bus members 206 each include the corresponding central walls 270 with the cable cradles 275 along the inner and outer surfaces 272, 274 to receive the various rows of the cables 102. The second outer bus member 206b is longer than the first outer bus member 206a. The third outer bus member 206c is longer than the second outer bus member 206b. For example, the lengths of the first segments 276 of the outer bus members 206 lengthen to elevate the cables 102 further from the circuit card 152 to overlap the inner rows of the cables 102. The second and third outer bus members 206b, 206c may not have a need for rear support members extending rearwardly out of the cable exit of the housing because the central walls 270 are of ample length to provide effective shielding.

In an exemplary embodiment, each cable 102 includes at least one signal conductor and a shield structure providing electrical shielding for the at least one signal conductor. In an exemplary embodiment, the cables 102 are twin-axial cables. For example, each cable 102 includes a first signal conductor 180 and a second signal conductor 182. The signal conductors 180, 182 carry differential signals. The signal conductors 180, 182 are configured to be electrically connected to corresponding circuit conductors 164 of the circuit card 152. However, the cables 102 may include greater or fewer signal conductors in alternative embodiments, such as being a coaxial cable.

The cable 102 includes one or more insulators 184 surrounding the signal conductors 180, 182 and a cable shield 190 surrounding the insulators 184. The cable shield 190 provides circumferential shielding around the signal conductors 180, 182. The cable 102 includes a cable jacket 192 surrounding the cable shield 190. In various embodiments, the cable 102 may include one or more drain wires electrically connected to the cable shield 190. In an exemplary embodiment, the cable jacket 192, the cable shield 190, and the insulators 184 may be removed (e.g., stripped) to expose portions of the signal conductors 180, 182 for termination to the circuit card 152 (or to the contact assembly). A portion of the cable shield 190 may be exposed for termination to the ground bus 200. The ground bus 200 extends along the exposed portions and provides shielding for the exposed portions. For example, the ground bus 200 may extend along the top, the bottom, and both sides of the cable 102. In an exemplary embodiment, the ground bus 200 physically engages, to electrically connect to, the cable shield 190 at multiple points of contact, such as along the top, the bottom and both sides of the cable shield 190. The ground bus 200 may be shaped and positioned relative to the exposed portions to control impedance along the signal paths. For example, the ground bus 200 may be shaped and positioned relative to the exposed portions to maintain a target impedance along the signal paths (for example, 50 Ohms, 75 Ohms, 10 Ohms, and the like).

During assembly, the inner bus member 204 is mounted to the circuit card 152. The tunnels 201 of the ground bus 200 are aligned with the cable termination areas. The inner bus member 204 includes multiple rows of the openings 242, corresponding to the tunnels 201, to receive the multiple rows of the cables 102. In an exemplary embodiment, a single inner bus member 204 is provided, which accommodates multiple rows and columns of the cables 102. The single inner bus member 204 is configured to be coupled to the circuit card 152 in a single assembly process (for example, a single reflow solder process), rather than coupling many individual cable shields around each individual cable 102.

During assembly, rows of the cables 102 are coupled to the circuit card 152, followed by coupling the corresponding outer bus member 206 to the inner bus member 204. As such, rows of the cables and outer bus members 206 may be stacked to form the cable card assembly 150. The outer bus members 206 shield or cover the tops of the cables 102. The ground bus 200 is configured to provide shielding for the cables 102. For example, the inner bus member 204 and the outer bus members 206 cooperate to form the tunnels 201 that receive the corresponding cables 102. Optionally, each tunnel 201 may receive a single (for example, different) cable 102. The ground bus 200 includes multiple rows of the tunnels 201 to receive the multiple rows of the cables 102. The cables 102 are received in the cable cradles 250 and the ends of the cables 102 are received in the openings 242 for termination to the circuit card 152. The shell 202 extends between the opening 136 at the mating end of the housing 120 to the cable exit port 135 at the cable end of the housing 120 to provide shielding between the cables 102 within the cavity 122 of the housing 120. For example, the cables 102 are entirely shielded by the ground bus within the housing 120, such as from the bottom to the rear of the housing 120 where the cables 102 exit the housing 120. In an exemplary embodiment, the ground shield 200 even provides shielding for the cables 102 exterior of the cavity 122 of the housing 120, such as rearward of the housing 120 along the support walls 160, 170.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
a housing having walls forming a cavity, the housing having a cable exit port at a cable end of the housing, the housing having an opening at a mating end of the housing; and
a cable card assembly received in the cavity of the housing, the cable card assembly including a circuit card, cables terminated to the circuit card, and a ground bus coupled to the circuit card;
the circuit card having an array of signal pads on a surface of the circuit card, the circuit card having a ground plane;
the cables including signal conductors and cable shields surrounding the corresponding signal conductors to provide electrical shielding for the signal conductors, the signal conductors being electrically connected to corresponding signal pads of the circuit card, the cables configured to exit the housing through the cable exit port; and
the ground bus being electrically connected to the cable shields of the cables, the ground bus being electrically connected to the ground plane of the circuit card, the ground bus including a shell forming tunnels receiving the corresponding cables, the tunnels being stacked to arrange the cables in multiple rows, the shell extending between the opening at the mating end of the housing to the cable exit port at the cable end of the housing to provide shielding between the cables within the cavity of the housing.

2. The electrical connector of claim 1, wherein the shell includes stacked bus members forming the tunnels, the cables being stacked between the bus members.

3. The electrical connector of claim 1, wherein the shell includes an inner bus member having a base mounted to the circuit card and outer bus members stacked on the inner bus members, the outer bus members having rear ends at or outside of the cable exit port of the housing.

4. The electrical connector of claim 1, wherein each tunnel extends between a first end and a second end, the first end located at the circuit card, the second end located at or outside of the cable exit port of the housing.

5. The electrical connector of claim 3, wherein the first end is located at a base of the shell, the second end located at a rear of the shell.

6. The electrical connector of claim 1, wherein the shell includes a base mounted to the circuit card and a rear at the cable exit port, all of the cables exiting the shell at the rear.

7. The electrical connector of claim 6, wherein the rear is stepped at different distances from a front of the shell.

8. The electrical connector of claim 1, wherein the tunnels extend from the circuit card a distance greater than 5 times a diameter of the cable to provide shielding along a length of each cable.

9. The electrical connector of claim 1, wherein the shell provides 360° shielding for each cable.

10. The electrical connector of claim 1, wherein the cable card assembly further comprises a cable strain relief coupled to the cables extending from the housing, the cable strain relief abutting against the shell.

11. The electrical connector of claim 1, wherein the tunnels are oversized relative to the corresponding cables forming clearance gaps in the tunnels accommodating bending of the cables in the tunnels.

12. The electrical connector of claim 1, wherein each tunnel includes a first section at a base of the shell and a second section at a rear of the shell, the first section mating the second section and a transition, the first section extending at an angle relative to the second section.

13. The electrical connector of claim 1, wherein the housing includes mounting tab pockets at the mating end, the mounting tabs being received in the mounting tab pockets, the mounting tabs include compliant pins protruding from the mating end of the housing, the compliant pins being press-fit into vias of the circuit card to couple the housing to the circuit card.

14. The electrical connector of claim 15, wherein the compliant pins extending pin distance from the mating end, the circuit card having a thickness greater than the pin distance.

15. An electrical connector comprising:
a housing having walls forming a cavity, the housing having a cable exit port at a cable end of the housing, the housing having an opening at a mating end of the housing, the housing including mounting tab pockets at the mating end;
mounting tabs received in the mounting tab pockets, the mounting tabs including compliant pins protruding from the mating end of the housing; and
a cable card assembly received in the cavity of the housing, the cable card assembly including a circuit card, cables terminated to the circuit card, and a ground bus coupled to the circuit card;
the circuit card having an array of signal pads on a surface of the circuit card, the circuit card having a ground plane, the circuit card including vias, wherein the compliant pins are press fit into the vias to secure the housing to the circuit card;
the cables including signal conductors and cable shields surrounding the corresponding signal conductors to provide electrical shielding for the signal conductors, the signal conductors being electrically connected to corresponding signal pads of the circuit card, the cables configured to exit the housing through the cable exit port; and
the ground bus being electrically connected to the cable shields of the cables, the ground bus being electrically connected to the ground plane of the circuit card, the ground bus including a shell forming tunnels receiving the corresponding cables.

16. The electrical connector of claim 18, wherein the mounting tabs are stamped and formed.

17. The electrical connector of claim 18, wherein the mounting tabs include locking lances locked to the housing in the mounting tab pockets to secure the mounting tabs in the mounting tab pockets.

18. The electrical connector of claim 18, wherein the compliant pins extending pin difference from the mating end, the circuit card having a thickness greater than the pin distance.

19. The electrical connector of claim 18, wherein, the tunnels are stacked to arrange the cables in multiple rows, the shell extending between the opening at the mating end of the housing to the cable exit port at the cable end of the housing to provide shielding between the cables within the cavity of the housing.

20. A communication system comprising:
a socket connector including a receptacle housing having sidewalls forming a socket with an opening to the socket, the socket connector including a socket substrate including socket contacts, the socket contacts including mating ends;
an electrical connector received in the socket through the opening and being mated with the mating ends of the socket contacts, the electrical connector including a housing holding a cable card assembly, the housing having walls forming a cavity, a cable exit port at a cable end of the housing, and an opening at a mating end of the housing, the housing being coupled to the socket connector, the cable card assembly including a circuit card, cables terminated to the circuit card, and a ground bus coupled to the circuit card, the circuit card having a first array of signal pads on a first surface of the circuit card, the circuit card having a second array of signal contacts on a second surface of the circuit card being mated with mating ends of the corresponding socket contacts, the cables including signal conductors and cable shields surrounding the corresponding signal conductors to provide electrical shielding for the signal conductors, the signal conductors being electrically connected to corresponding signal pads of the circuit card, the cables configured to exit the housing through the cable exit port, the ground bus being electrically connected to the cable shields of the cables, the ground bus being electrically connected to a ground plane of the circuit card, the ground bus including a shell forming tunnels receiving the corresponding cables, the tunnels being stacked to arrange the cables in multiple rows, the shell extending between the opening at the mating end of the housing to the cable exit port at the cable end of the housing to provide shielding between the cables within the cavity of the housing.
